(19) United States
(12) Patent Application Publication
(10) Pub. No.: US 2026/0318396 A1
(43) Pub. Date: Oct. 15, 2026

(54) ELECTRONIC LOCKING DIFFERENTIAL

(71) Applicant: Eaton Intelligent Power Limited, Dublin (IE)

(72) Inventors: Ram Palaskar, Pune (IN); Mohit Aggarwal, Pune (IN); Andrew N. Edler, Homer, MI (US); Matthew G. Fox, Ceresco, MI (US); Milind Sadashiv Shinde, Pune (IN)

(73) Assignee: Eaton Intelligent Power Limited, Dublin (IE)

(21) Appl. No.: 19/485,060

(22) PCT Filed: May 30, 2024
(86) PCT No.: PCT/IB2024/055313

§ 371 Date: Nov. 17, 2025

(30) Foreign Application Priority Data
May 30, 2023 (IN) 202311037170

(51) Int. Cl. F16H 48/34; F16H 48/08; F16H 48/24; F16H 48/40

(52) U.S. Cl. CPC F16H 48/34; F16H 48/08; F16H 48/24; F16H 48/40

(57) ABSTRACT

A locking differential transitions between a locking configuration and an non-locking configuration via an axially movable locking arrangement. The locking arrangement includes pins maintaining a constant distance between a locking collar and a positioning collar. The positioning collar is coupled, directly or indirectly, to a ferrous frame for unitary axial motion. Energizing an electro-magnet attracts the frame so that the entire locking arrangement is pulled to the locking configuration. A spring biases the locking arrangement back to the non-locking configuration when energization ceases.

### CROSS-REFERENCE TO RELATED APPLICATIONS

This application claims priority to Indian Provisional Patent Application Serial No. 202311037170, filed May 30, 2023, the disclosure of which is incorporated herein by reference in its entirety.

### BACKGROUND

During normal operation of a motor vehicle, it is common that all four wheels are not turning at an identical rate of speed. Different wheel turn rates are most commonly encountered when the vehicle is making a turn, but may also be caused by braking or non-uniform road surface conditions. In order to accommodate differing wheel turning rates while continuing to direct power to two wheels, a differential is configured to allow for different wheel turn rates between the powered wheels. The differential allows the wheels to spin at different rates while transmitting torque to each wheel.

While this solution may be satisfactory in some driving conditions, it is unsatisfactory under conditions where one of the driven wheels experiences a surface having a much lower coefficient of friction than a surface engaged by the other wheel(s). Such conditions may prevent the application of torque to a wheel with more traction, thereby resulting in undesired vehicle performance. A locking mechanism may be provided to lock the differential and prevent different wheel spin rates and transmit torque uniformly between two wheels in at least some circumstances.

### SUMMARY

In accordance with certain aspects of the disclosure, a differential assembly includes a locking arrangement that is moveable relative to a gear housing. The locking arrangement includes a locking collar; an armature arrangement; and a pin. The locking collar is movable relative to a locking gear within the gear housing between a locking position and a non-locking position. The locking collar engages the locking gear to rotationally fix the locking collar and locking gear together when in the locking position. The locking collar is rotatable relative to the locking gear when in the non-locking position. The armature arrangement includes an armature frame that is axially movable between first and second positions. The armature frame is biased to the first position. The armature frame is formed of ferrous material. A first end of the pin is axially fixed to the locking collar and a second end of the pin is axially fixed to the armature arrangement.

In certain implementations, the armature arrangement includes a positioning collar that is axially fixed to the armature frame. The positioning collar is rotatable relative to the armature frame. The second end of the pin is axially fixed to the positioning collar.

In some examples, the second end of the pin is press fit to the positioning collar.

In other implementations, the second end of the pin is held to the positioning collar by a snap-ring.

In certain implementations, the pin is one of a plurality of pins. A first end of each pin is axially fixed to the locking collar and a second end of each pin is axially fixed to the armature arrangement.

In accordance with other aspects of the disclosure, a method of operating a locking differential includes: energizing an electro-magnet to attract a ferrous armature arrangement from a first position to a second position against a biasing force; and moving a locking collar in unison with the armature arrangement by pulling on a pin connecting the locking collar with the armature arrangement so that the locking collar moves from a non-locking position to a locking position.

In certain implementations, the method also includes deenergizing the electro-magnet to enable the biasing force to move the armature arrangement back to the first position.

In accordance with other aspects of the disclosure, a locking differential includes a stator including an electro-magnet; a gear housing configured to rotate relative to the stator; a differential gear set including a locking gear; and a locking arrangement mounted to the gear housing. The locking arrangement includes a locking collar; an armature arrangement; a biasing member; and a pin. The locking collar is disposed within the gear housing. The locking collar is movable relative to the locking gear between a locking position and a non-locking position. The armature arrangement is disposed external of the gear housing. The armature arrangement includes an armature frame that is rotationally stationary relative to the stator. The armature frame is axially movable relative to the stator between first and second positions. The armature frame is configured to move to the second position when the electro-magnet is energized. The biasing member is disposed between the stator and the armature frame to bias the armature frame to the first position. The pin extends between the locking collar and the armature arrangement. The pin is configured to maintain a separation distance between the locking collar and the armature frame so that the locking collar is disposed in the non-locking position when the armature frame is disposed in the first position and the locking collar is disposed in the locking position when the armature frame is disposed in the second position.

In certain implementations, the biasing member is disposed external of the differential housing.

In certain implementations, the armature arrangement includes a positioning collar disposed external of the gear housing. The pin is axially fixed relative to the positioning collar and the positioning collar is axially fixed relative to the armature frame.

In some examples, the armature frame includes the protruding flange that is axially fixed between the groove defined by the positioning collar and a snap-ring axially fixing the pin to the collar.

In other implementations, the positioning collar includes the protruding flange that extends into a groove defined by the armature frame to axially fix the positioning collar with the armature frame.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the embodiments disclosed herein are based.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 is a perspective view of an example locking differential configured in accordance with the principles of the present disclosure.

FIG. 2 is a first perspective view of the locking differential of FIG. 1 with the components exploded outwardly from each other.

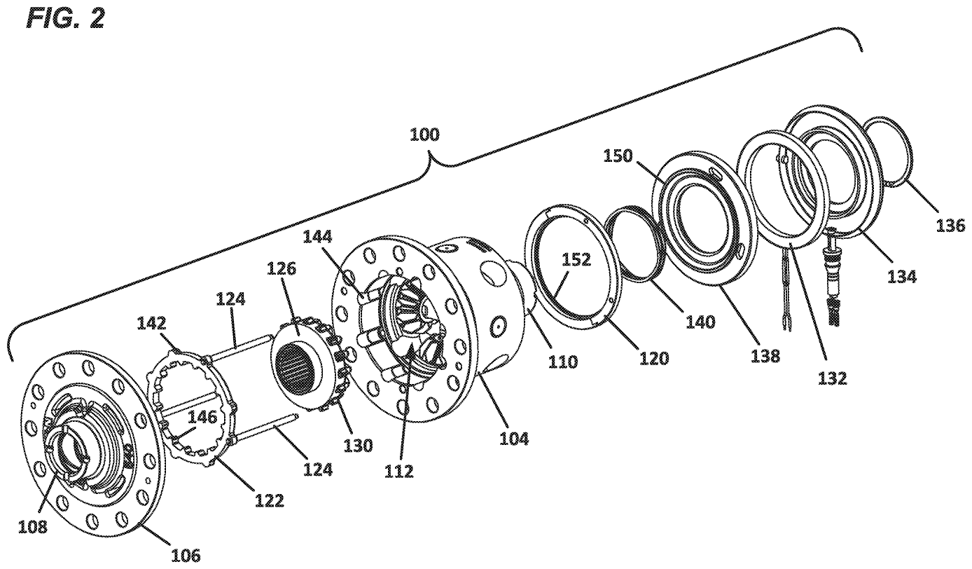

FIG. 3 is a second perspective view of the locking differential of FIG. 1 with the components exploded outwardly from each other.

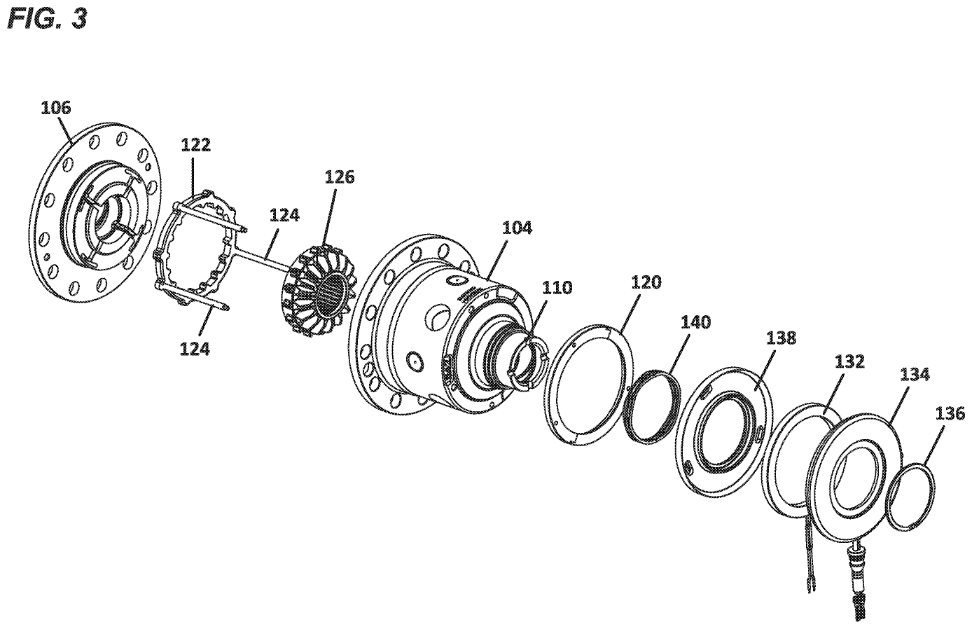

FIG. 4 is a cross-section taken of the locking differential of FIG. 1.

FIG. 5 is a perspective view of a first example implementation of a locking arrangement that is axially movable relative to a gear housing of the locking differential while being rotationally fixed relative to the gear housing.

FIG. 6 is a cross-sectional view of the locking arrangement of FIG. 5.

FIG. 7 is a perspective view of the cross-section of FIG. 4.

FIG. 8 is an enlarged view of a portion of FIG. 7.

FIG. 9 is another perspective view of the cross-section of FIG. 4.

FIG. 10 is an enlarged view of a portion of FIG. 9.

FIG. 11 is a cross-sectional view of a second example implementation of a locking arrangement in which the pins are clipped to a positioning collar.

FIG. 12 shows the second end of an example pin of the locking arrangement of FIG. 11 attached to the positioning collar using a clip, which engages a frame of the locking arrangement.

FIG. 13 is an enlarged view of a portion of FIG. 4.

FIG. 14 shows a weld further securing the second end of the pin of FIG. 13 to the positioning collar.

FIG. 15 shows the pin of FIG. 13 held at the positioning collar using a first type fastener.

FIG. 16 shows the pin of FIG. 13 held at the positioning collar using a second type fastener.

FIG. 17 shows the pin of FIG. 13 held at the positioning collar using a third type fastener.

FIG. 18 shows an alternative locking arrangement design in which the biasing member is disposed inside the gear housing.

### DETAILED DESCRIPTION

Reference will now be made in detail to exemplary aspects of the present disclosure that are illustrated in the accompanying drawings. Wherever possible, the same reference numbers will be used throughout the drawings to refer to the same or like parts.

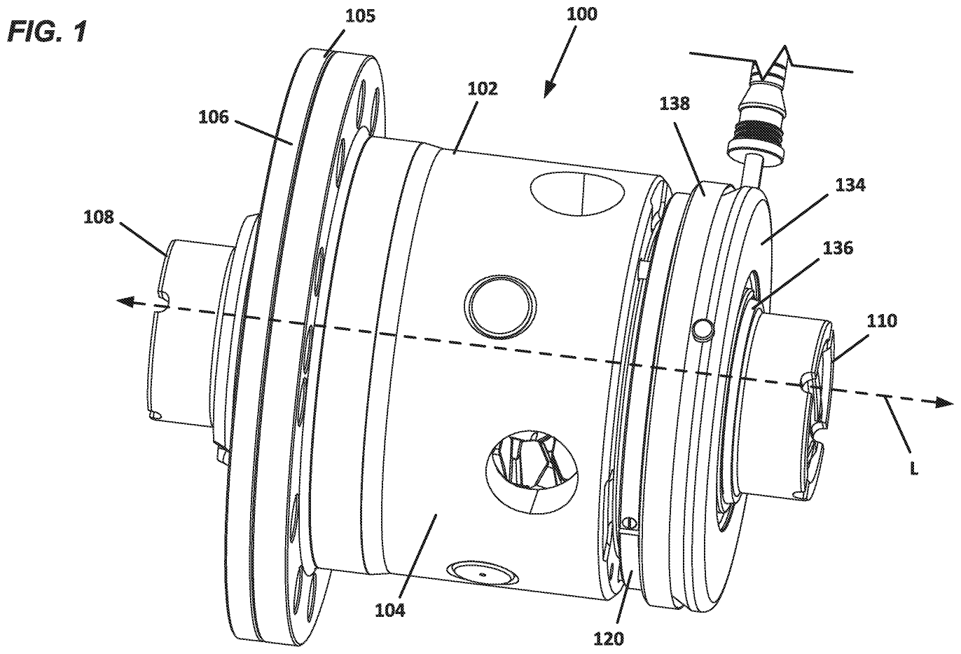

FIG. 1 shows a locking differential 100 for a vehicle. The locking differential 100 includes a gear housing 102 (e.g., a gear case 104 and an end cap 106) configured to rotate about a longitudinal axis L of the gear housing 102. Torque input to the locking differential 100 can be provided by an input ring gear (not shown) to a flange 105 of the gear housing 102. The gear housing 102 defines annular hub portions 108 and 110 at which left and right axle shafts are coupled. A pair of bearing sets (not shown) disposed at the annular hub portions 108, 110 provide rotational support for the rotating differential device 100 relative to an outer differential housing or “carrier” (also not shown). The rotatable housing 102 defines a gear chamber 112 in which a differential gear set 114 is disposed.

The locking differential 100 can be operated in a locked mode or an unlocked mode. When operated in the locked mode, one or both side gears 126, 128 of the differential gear set 114 are locked against rotation relative to the gear housing 102. When operated in the unlocked mode, the side gears 126, 128 are free to spin relative to the gear housing 102. For example, the side gears 126, 128 may be configured to independently rotate about the longitudinal axis L of the gear housing 102. In some implementations, the locking differential 100 is transitioned between locked and unlocked modes manually by a user. In other implementations, the locking differential 100 is transitioned between locked and unlocked modes automatically (e.g., by a microprocessor of the vehicle based on a sensed operational condition of the vehicle).

The locking differential 100 includes a locking arrangement 118 that can be transitioned between a locking configuration and a non-locking configuration. When disposed in the locking configuration, the locking arrangement 118 inhibits independent rotation of the side gear 126 from the gear housing 102. When disposed in the non-locking configuration, the locking arrangement 118 allows independent rotation of the side gear 126 relative to the gear housing 102.

In certain implementations, the locking arrangement 118 includes an armature arrangement 119 and a locking collar 122 spaced apart by one or more pins 124. The pins 124 are configured to maintain a constant spacing between the armature arrangement 119 and the locking collar 122. The locking collar 122 is engaged with the gear housing 102 so that the locking collar 122 spins in unison with the gear housing 102. The locking collar 122 is configured to engage a locking gear 130 when the locking arrangement 118 is disposed in the locking configuration. The locking collar 122 is disengaged from the locking gear 130 when the locking arrangement 118 is disposed in the non-locking configuration.

The armature arrangement 119 includes an armature frame 138 that is rotationally stationary relative to a stator 134. The armature frame 138 is axially movable relative to the stator 134 between first and second positions. The stator 134 is disposed external to the gear housing 102. For example, the stator 134 may form a ring surrounding the annular hub portion 110. The gear housing 102 rotates relative to the stator 134. A snap-ring 136 axially retains the stator 134 at the gear housing 102 (e.g., at the annular hub portion 110). The locking collar 122 is disposed within the gear housing 102. The pins 124 extend through the gear housing 102 between the locking collar 122 and the armature arrangement 119. In some examples, the pins 124 are guided by tight passages defined by the gear housing 102. In other examples, the pins 124 are gear housing 102 defines passthrough channels 103 within which the pins 124 slide without contacting the inner surfaces of the passthrough channels 103. The armature arrangement 119 also includes a positioning collar 120 at which the pins 124 are received. The positioning collar 120 is configured to rotate relative to the armature frame 138 while remaining axially fixed relative to the armature frame 138.

In certain implementations, the locking arrangement 118 is biased to the non-locking configuration by a biasing member 140 (e.g., wave spring). In certain implementations, the locking arrangement 118 is transitioned from the non-locking configuration to the locking configuration against the bias of the spring 140 using an electro-magnet 132. In certain examples, the armature frame 138 is formed of ferrous material. When the electro-magnet 132 is energized, the electro-magnet 132 attracts the armature frame 138, causing the armature frame 138 to move axially along the axis L relative to the gear housing 102. The armature frame 138 axially moves with a remainder of the locking arrangement 118 as a unit, thereby axially moving the locking collar 122 to the locking configuration.

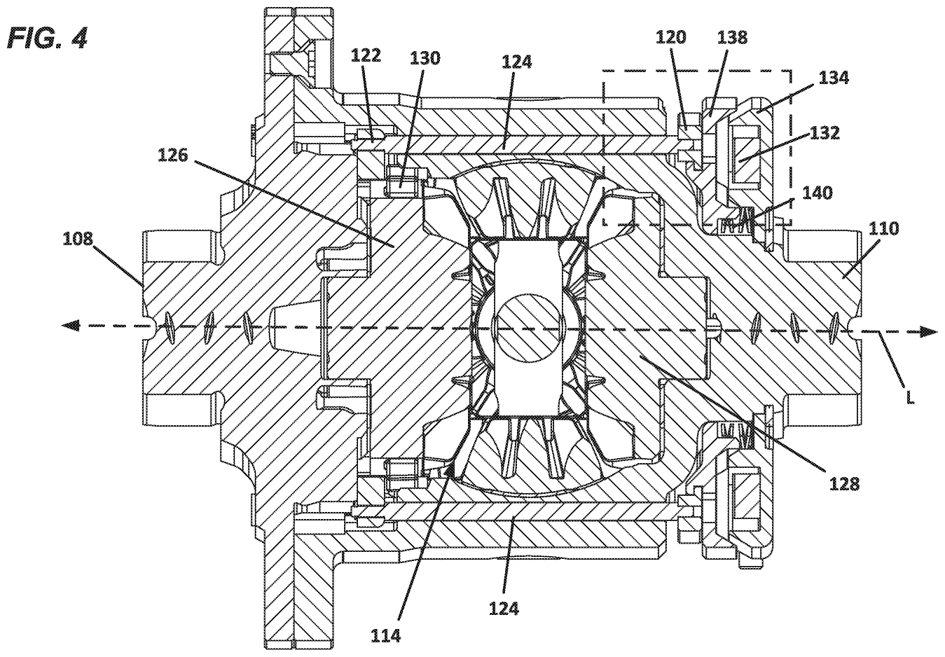

In certain examples, the electro-magnet 132 is disposed at the stator 134. The stator 134 is disposed external of the gear housing 102. The armature arrangement 119 also is disposed external of the gear housing 102. For example, the armature frame 138 and the positioning collar 120 may be annular members surrounding the annular hub portion 110. In some implementations, the biasing member 140 is disposed external of the gear housing 102. In certain such examples, the biasing member 140 is disposed between the stator 134 and the armature frame 138. For example, an axial end of the biasing member 140 may contact the armature frame 138 (e.g., a catch surface 156) while an opposite axial end of the biasing member 140 contacts the stator 134 (e.g., see FIG. 4). In other implementations, the biasing member 140 is disposed within the gear housing 102. For example, the biasing member 140 can be disposed between the locking collar 122 and an inner shoulder 141 of the gear housing 102. In such examples, the biasing member 140 pushes the locking collar 122 away from the inner shoulder 141, and thereby pulls the pins 124, which pull the positioning collar 120 against the armature frame 138 to draw the armature frame 138 away from the electro-magnet 132.

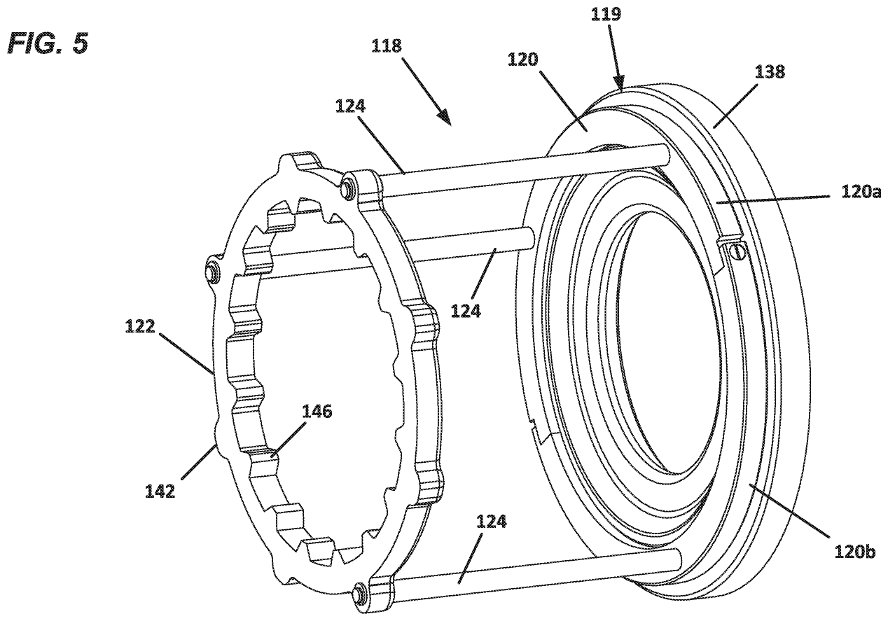

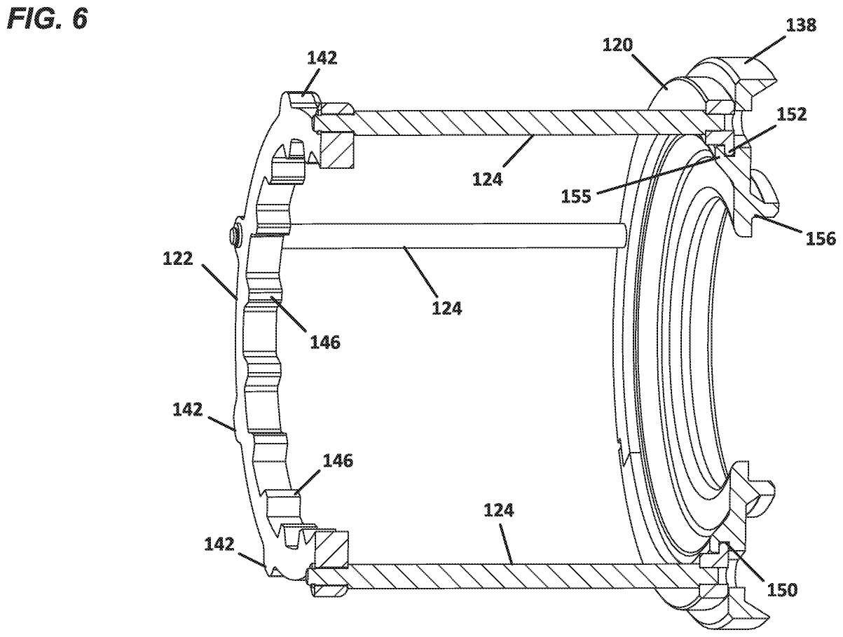

Referring to FIGS. 5-6, the locking arrangement 118 is assembled to move unitarily relative to the gear set and gear housing 102. In certain implementations, the locking collar 122 has an outer periphery configured to engage an inner surface of the gear housing 102 to rotationally fix the locking collar 122 to the gear housing 102 while allowing the locking collar 122 to move axially relative to the gear housing 102. In certain examples, the locking collar 122 includes one or more ears 142 that slide along respective grooves 144 defined by the gear housing 102 (e.g., by the gear case 104). Engagement between the ears 142 and the grooves 144 inhibits rotation between the locking collar 122 and the gear housing 102. The grooves 144 are sufficiently long to accommodate movement of the locking collar 122 between the locking and non-locking configurations.

In certain implementations, the locking collar 122 also is configured to engage the locking gear 130 when disposed in the locking configuration. In certain examples, the locking collar 122 has an inner periphery defining teeth 146 or other protrusions that intermesh with teeth of the locking gear 130. In certain examples, the locking gear 130 is formed around an outer periphery of the side gear 126. When in the locking configuration, the locking collar 122 is axially positioned to radially align sufficiently with the locking gear 130 to mesh the teeth 146 with the locking gear 130. Cooperating between the teeth 146 and the locking gear 130 and cooperating between the ears 142 and the grooves 144 causes the locking gear 130, and hence the side gear 126, to rotate in unison with the gear housing 102. When in the non-locking configuration (e.g., see FIG. 4), the locking collar 122 is axially spaced out of radial alignment with the locking gear 130 so that the teeth 146 of the locking collar 122 do not mesh with the locking gear 130. Accordingly, the locking gear 130, and hence the side gear 126, can spin independently of the gear housing 102 and locking collar 142.

In certain implementations, the armature frame 138 of the locking arrangement 118 has a first axial end facing towards the gear set and an opposite second axial end facing away from the gear set. The armature frame 138 defines an annular groove 150 at the first axial end. For example, the armature frame 138 may include an axial extension 155 in which the annular groove 150 is defined (e.g., see FIG. 6). An annular open surface of the groove 150 faces radially outwardly from the longitudinal axis of the differential 100. The second axial end of the armature frame 138 defines the catch surface 156 for the biasing member 140 (e.g., see FIG. 6).

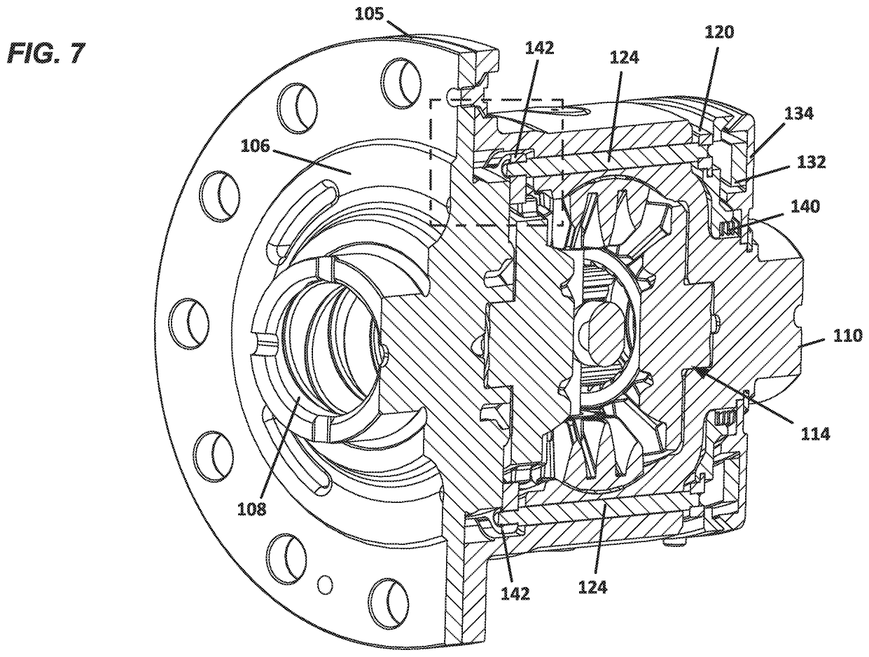

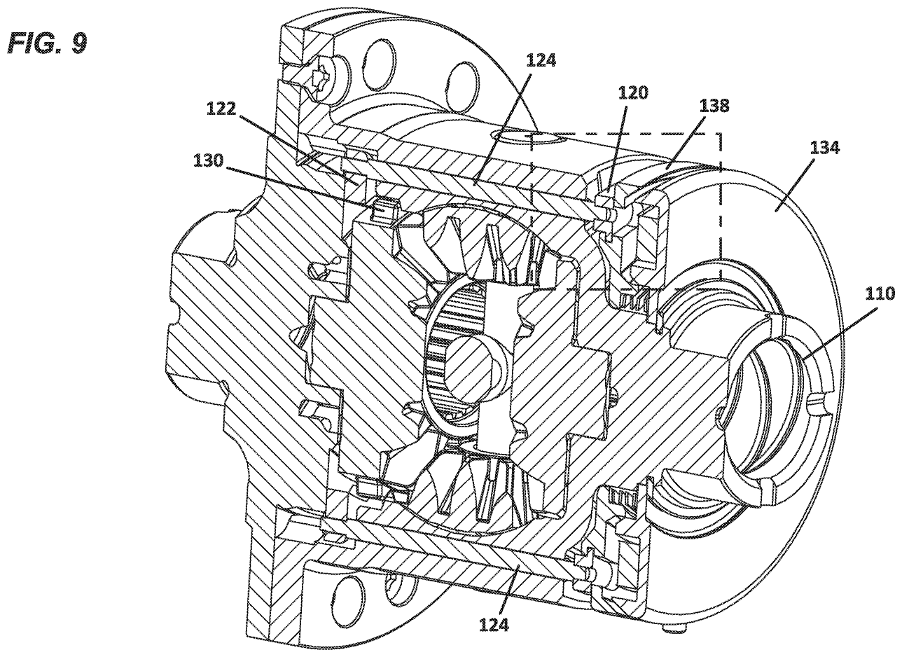

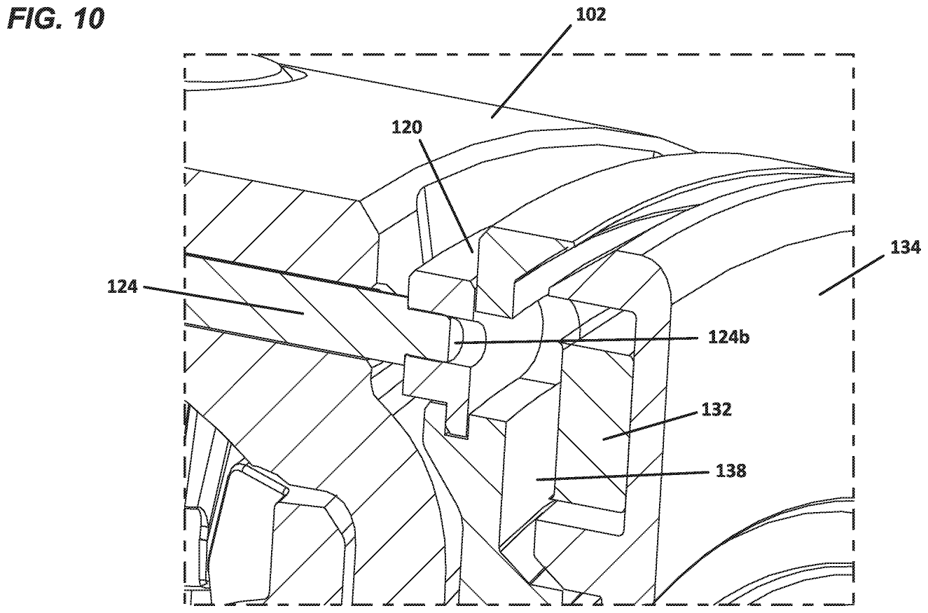

FIGS. 5-10 illustrate one possible way the locking arrangement 118 can be assembled. The positioning collar 120 includes a radially inward flange 152 configured to extend into the groove 150 of the armature frame 138 when the locking arrangement 118 is assembled (e.g., see FIG. 6). Engagement between the flange 152 and the groove 150 axially fixes the positioning collar 120 and the armature frame 138 relative to each other. Accordingly, when the frame 138 is attracted to the electro-magnet 132 at the stator 134, the armature frame 138 pulls the positioning collar 120 along with it. In certain implementations, the positioning collar 120 can be formed from multiple pieces (e.g., see FIG. 5) to facilitate mounting the positioning collar 120 to the armature frame 138. In the example shown, the positioning collar 120 is formed from a first piece 120a and a second piece 120b.

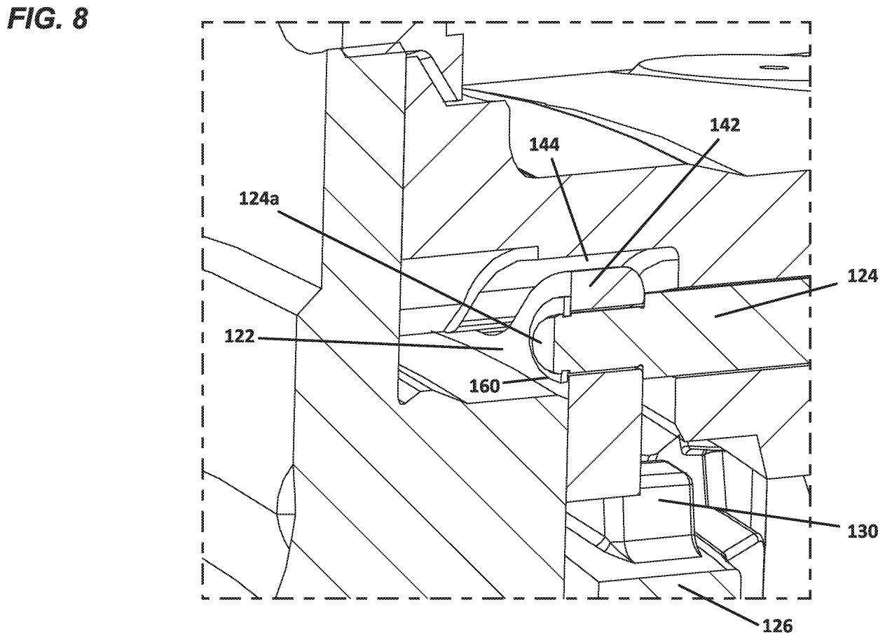

The pins 124 extend between opposite first and second ends 124a, 124b. The first ends 124a are axially fixed at the locking collar 122. In the example shown in FIGS. 5-10, the first ends 124a of the pins 124 are held at the locking collar 122 using clips 160 (e.g., snap-rings). For example, the first end 124a of a pin 124 may extend through one of the ears 142 of the locking collar 122 and through a snap-ring 160 (e.g., see FIG. 8). In certain examples, the ears 142 holding the pins 122 are larger than the other ears 142. In other implementations, the first ends 124a of the pins 124 can be held at the locking collar 122 using press fit connections, threads, adhesive, welds, etc.

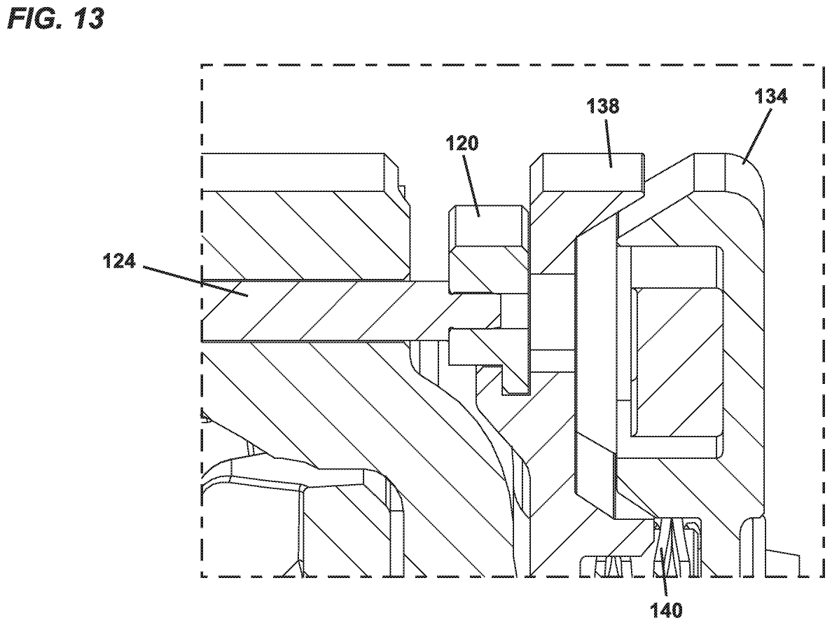

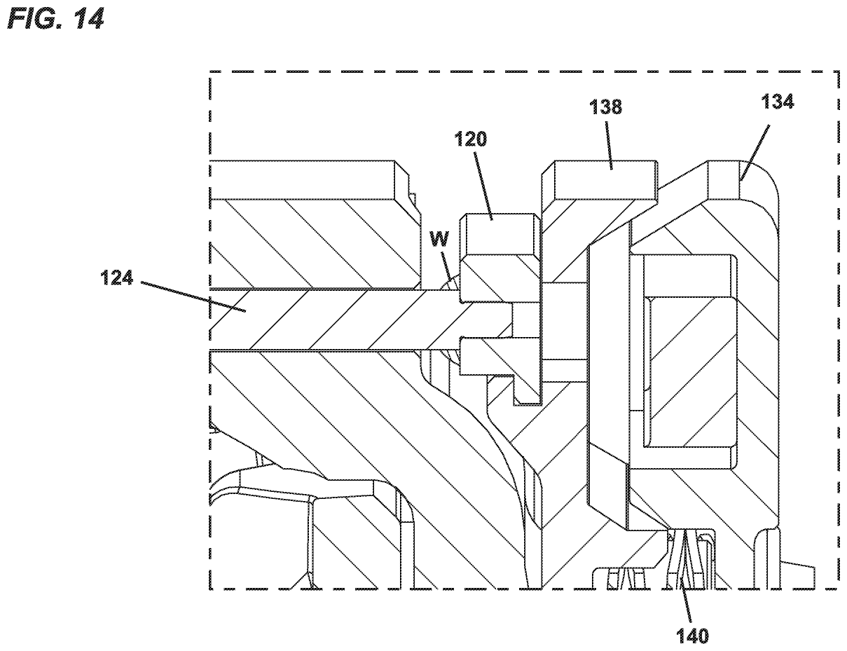

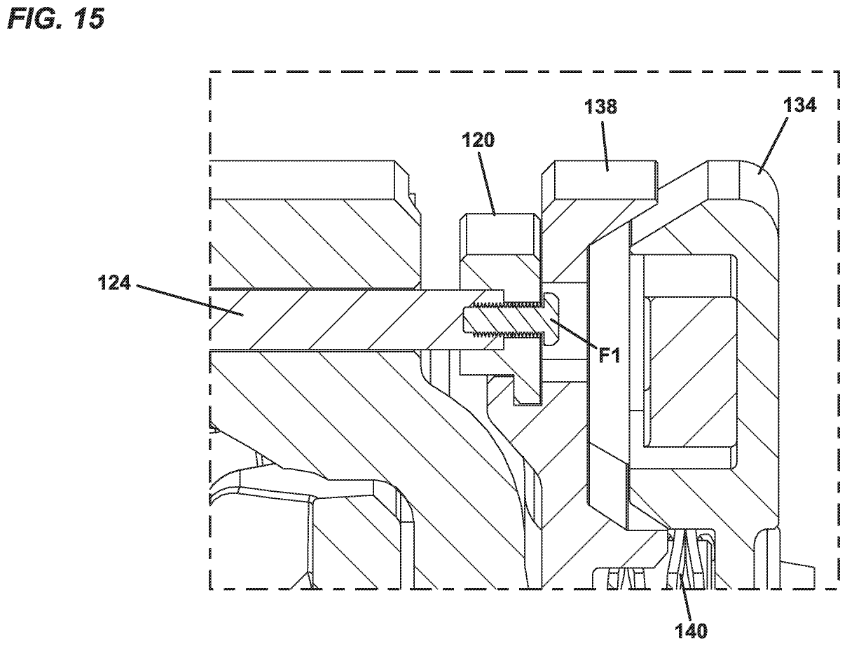

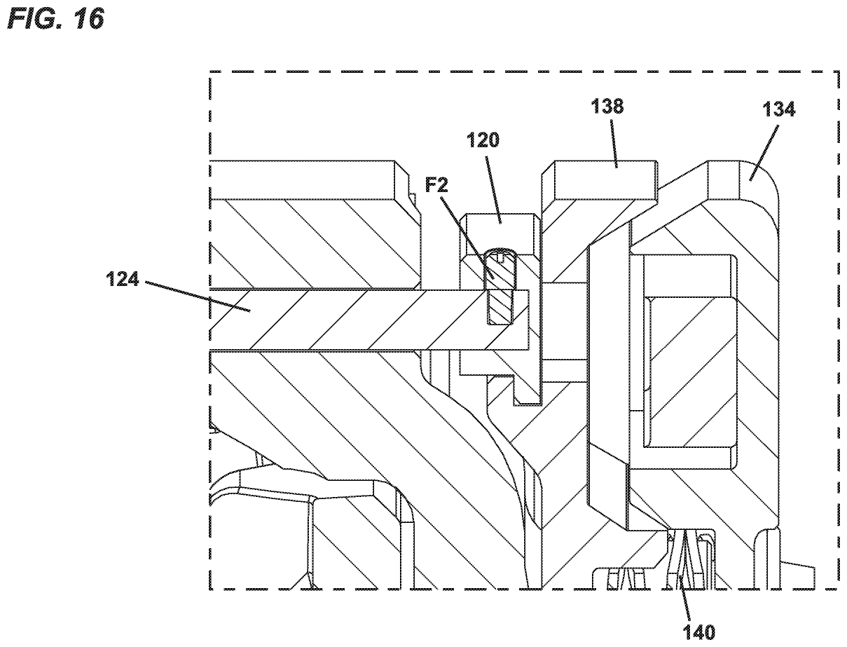

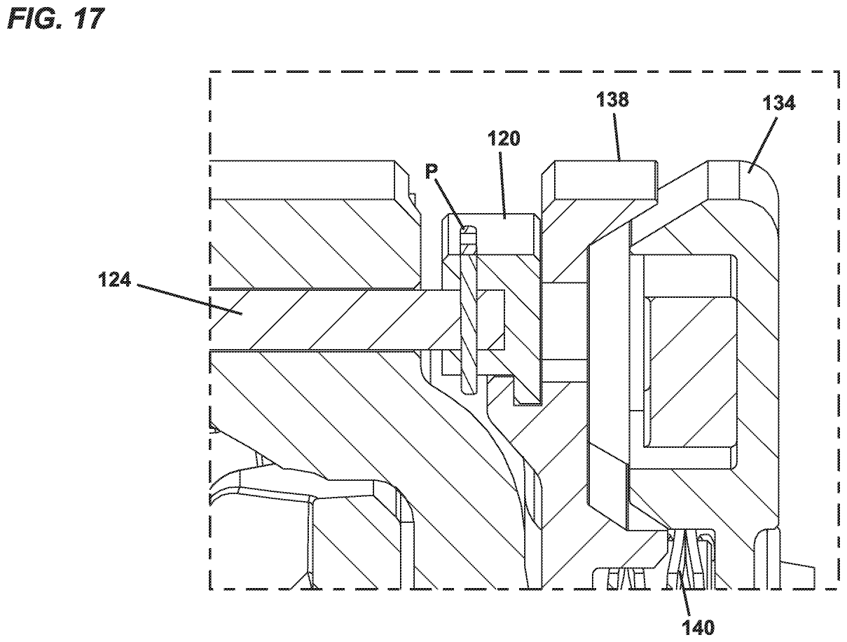

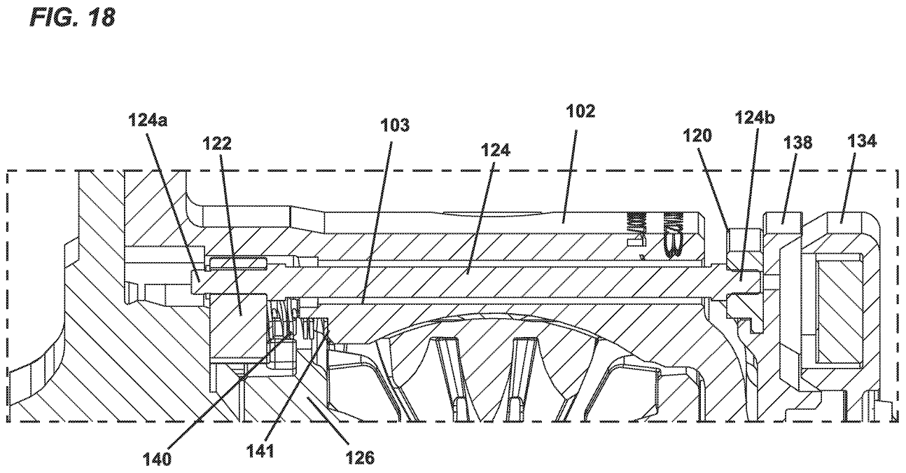

The second ends 124b are axially fixed at the positioning collar 120. In the example shown in FIGS. 5-10 and 13, the second ends 124b of the pins 124 are press fit to the positioning collar 120. In other implementations, the second ends 124b of the pins 124 can be welded (see weld W) to the positioning collar 120 (e.g., see FIG. 14). For example, the pins 124 can be press-fit into the positioning collar 120 with welds W. In other examples, the second ends 124b of the pins 124 can be fastened to the positioning collar 120 using fasteners. Alternatively, an example screw type fastener F1 is shown in FIG. 15 to secure a pin 124 to the positioning collar 120; an example set screw type fastener F2 is shown in FIG. 16 to secure a pin 124 to the positioning collar 120; and an example split pin type fastener P is shown in FIG. 17 to secure a pin 124 to the positioning collar 120. A threaded connection between the pin 124 and the positioning collar 120 is shown in FIG. 18.

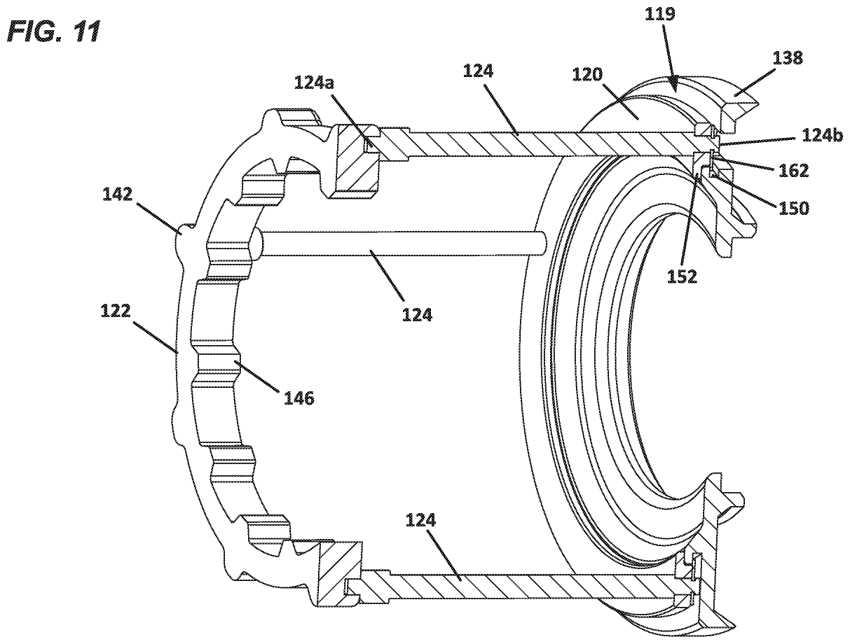

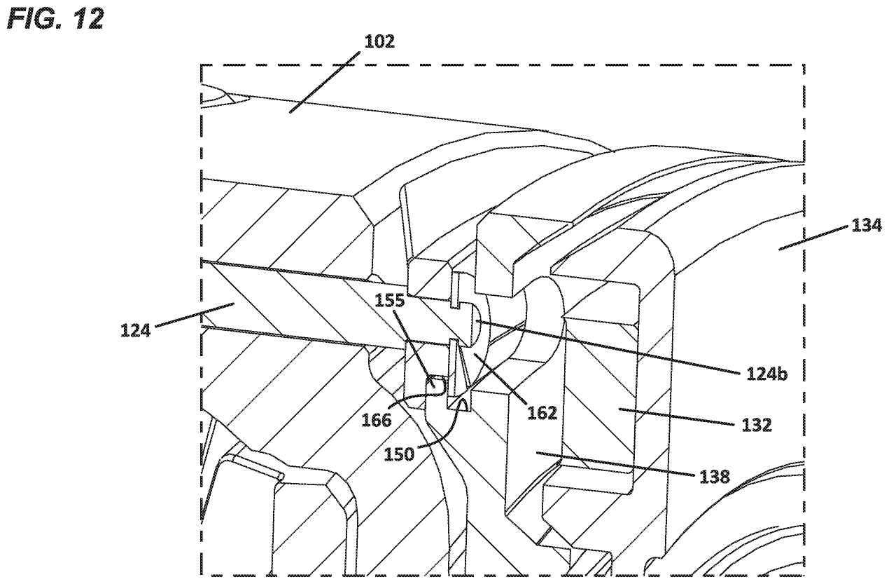

FIGS. 11-12 illustrate another possible way the locking arrangement 118 can be assembled. The positioning collar 120 includes a radially inward flange 152 that does not extend into the groove 150 of the frame 138. Rather, the flange 152 is formed by an annular groove define at the side of the positioning collar 120 facing towards the stator 134. The axial extension 155 of the armature frame 138 rides in the groove 166 as the positioning collar 120 and pins 124 rotate relative to the armature frame 138 (e.g., see FIG. 12). The second ends 124b of the pins 124 are axially held at the positioning collar 120 using clips 162 (e.g., snap-rings).

In certain implementations, the clips 162 extend parallel to the flange 152. In certain implementations, the clips 162 are sized to extend radially outwardly from the pin ends 124b and into the groove 150 of the armature frame 138. Accordingly, a portion of the armature frame 138 is sandwiched between the radial flange 152 of the positioning collar 120 and the clip 162. Accordingly, when the frame 138 is axially moved towards the electro-magnet 132, the armature frame 138 pulls the clips 162, which pull the pins 124, which pull the locking collar 122. In other implementations, the second ends 124b of the pins 124 can be held at the positioning collar 120 using clips, threads, adhesive, welds, etc.

The first ends 124a of the pins 124 are press fit to the locking collar 122. For example, the first ends 124a may terminate part-way through the locking collar 122. In certain examples, the first ends 124a are press fit into the ears 142 of the locking collar 122. In other implementations, the first ends 124a of the pins 124 can be held at the locking collar 122 using clips, threads, adhesive, welds, etc.

Examples of the disclosure may be described according to the following aspects.

Aspect 1. A differential assembly comprising:
a stator including an electro-magnet;
a gear housing configured to rotate relative to the stator;
a differential gear set disposed within the gear housing, the differential gear set including a locking gear;
a locking arrangement mounted to the gear housing, the locking arrangement including:
a locking collar disposed within the gear housing, the locking collar being movable relative to the locking gear between a locking position and a non-locking position;
an armature arrangement disposed external of the gear housing, the armature arrangement including an armature frame that is rotationally stationary relative to the stator, the armature frame being axially movable relative to the stator between first and second positions, the armature frame being configured to move to the second position when the electro-magnet is energized;
a biasing member disposed between the stator and the armature frame to bias the armature frame to the first position; and
a pin extending between the locking collar and the armature arrangement, the pin being configured to maintain a separation distance between the locking collar and the armature frame so that the locking collar is disposed in the non-locking position when the armature frame is disposed in the first position and the locking collar is disposed in the locking position when the armature frame is disposed in the second position.

Aspect 2. The differential assembly of aspect 1, wherein the biasing member is disposed external of the gear housing.

Aspect 3. The differential assembly of aspect 1, wherein the biasing member has a first axial end engaging the stator and a second axial end engaging the armature frame.

Aspect 4. The differential assembly of aspect 1, wherein the biasing member includes a wave spring.

Aspect 5. The differential assembly of any of aspects 1-4, wherein the armature arrangement includes a positioning collar disposed external of the gear housing, the pin being axially fixed relative to the positioning collar and the positioning collar being axially fixed relative to the armature frame.

Aspect 6. The differential assembly of aspect 5, wherein one of the armature frame and the positioning collar includes a protruding flange and the other of the armature frame and the positioning collar defines a groove that receives the protruding flange.

Aspect 7. The differential assembly of aspect 6, wherein the armature frame includes the protruding flange; and wherein the protruding flange is axially fixed between the groove defined by the collar and a snap-ring axially fixing the pin to the positioning collar.

Aspect 8. The differential assembly of aspect 6, wherein the positioning collar includes the protruding flange; and wherein the protruding flange extends into the groove defined by the armature frame to axially fix the collar with the armature frame.

Aspect 9. The differential assembly of aspect 5, wherein the positioning collar is configured to directly engage the armature frame when the armature frame is being moved to the second position.

Aspect 10. The differential assembly of aspect 1, wherein the pin directly engages the armature frame when the armature frame is being moved to the second position.

Aspect 11. The differential assembly of aspect 1, wherein the pin is press fit to the locking collar.

Aspect 12. The differential assembly of any of aspects 1-11, wherein the pin is one of a plurality of pins that extend between the locking collar and the armature arrangement.

Aspect 13. A locking arrangement for a locking differential, the locking arrangement including:
a locking collar movable between a locking position and a non-locking position relative to a locking gear of a locking differential, the locking collar engaging the locking gear to rotationally fix the locking collar and locking gear together when in the locking position, the locking collar being rotatable relative to the locking gear when in the non-locking position;
an armature arrangement including an armature frame that is axially movable between first and second positions, the armature frame being biased to the first position, and the armature frame being formed of ferrous material; and
a pin extending between opposite first and second ends, the first end of the pin being axially fixed to the locking collar and the second end of the pin being axially fixed to the armature arrangement.

Aspect 14. The locking arrangement of aspect 13, wherein the armature arrangement includes a positioning collar that is axially fixed to the armature frame, the positioning collar being rotatable relative to the armature frame; and wherein the second end of the pin is axially fixed to the positioning collar.

Aspect 15. The locking arrangement of aspect 14, wherein the second end of the pin is press fit to the positioning collar.

Aspect 16. The locking arrangement of aspect 14, wherein the second end of the pin is held to the positioning collar by a snap-ring.

Aspect 17. The locking arrangement of any of aspects 13-16, wherein the pin is one of a plurality of pins, each of the pins extending between respective first ends and respective second ends, the first end of each pin being axially fixed to the locking collar and the second end of each pin being axially fixed to the armature arrangement.

Aspect 18. The locking arrangement of any of aspects 13-17, wherein the armature frame is biased to the first position by a biasing member disposed at an opposite side of the armature frame from the pin.

Aspect 19. The locking arrangement of any of aspects 13-18, further comprising a stator holding an electro-magnet, the electro-magnet configured to move the armature arrangement to the second position when the electro-magnet is energized.

Aspect 20. A method of operating a locking differential comprising:
energizing an electro-magnet to attract a ferrous armature arrangement from a first position to a second position against a biasing force; and
moving a locking collar in unison with the armature arrangement by pulling on a pin connecting the locking collar with the armature arrangement so that the locking collar moves from a non-locking position to a locking position.

Aspect 21. The method of aspect 20, further comprising deenergizing the electro-magnet to enable the biasing force to move the armature arrangement back to the first position.

Having described the preferred aspects and implementations of the present disclosure, modifications and equivalents of the disclosed concepts may readily occur to one skilled in the art. However, it is intended that such modifications and equivalents be included within the scope of the claims which are appended hereto.

1. A differential assembly comprising:
a stator including an electro-magnet;
a gear housing configured to rotate relative to the stator;
a differential gear set disposed within the gear housing, the differential gear set including a locking gear;
a locking arrangement mounted to the gear housing, the locking arrangement including:
a locking collar disposed within the gear housing, the locking collar being movable relative to the locking gear between a locking position and a non-locking position;
an armature arrangement disposed external of the gear housing, the armature arrangement including an armature frame that is rotationally stationary relative to the stator, the armature frame being axially movable relative to the stator between first and second positions, the armature frame being configured to move to the second position when the electro-magnet is energized;
a biasing member configured to bias the armature frame to the first position; and
a pin extending between the locking collar and the armature arrangement, the pin being configured to maintain a separation distance between the locking collar and the armature frame so that the locking collar is disposed in the non-locking position when the armature frame is disposed in the first position and the locking collar is disposed in the locking position when the armature frame is disposed in the second position.

2. The differential assembly of claim 1, wherein the biasing member is disposed external of the gear housing.

3. The differential assembly of claim 2, wherein the biasing member has a first axial end engaging the stator and a second axial end engaging the armature frame.

4. The differential assembly of claim 1, wherein the biasing member is disposed within the gear housing.

5. The differential assembly of claim 1, wherein the armature arrangement includes a positioning collar disposed external of the gear housing, the pin being axially fixed relative to the positioning collar and the positioning collar being axially fixed relative to the armature frame.

6. The differential assembly of claim 5, wherein one of the armature frame and the positioning collar includes a protruding flange and the other of the armature frame and the positioning collar defines a groove that receives the protruding flange.

7. The differential assembly of claim 6, wherein the armature frame includes the protruding flange; and wherein the protruding flange is axially fixed between the groove defined by the collar and a snap-ring axially fixing the pin to the positioning collar.

8. The differential assembly of claim 6, wherein the positioning collar includes the protruding flange; and wherein the protruding flange extends into the groove defined by the armature frame to axially fix the collar with the armature frame.

9. The differential assembly of claim 5, wherein the positioning collar is configured to directly engage the armature frame when the armature frame is being moved to the second position.

10. The differential assembly of claim 1, wherein the pin directly engages the armature frame when the armature frame is being moved to the second position.

11. The differential assembly of claim 1, wherein the pin is press fit to the locking collar.

12. The differential assembly of claim 1, wherein the pin is one of a plurality of pins that extend between the locking collar and the armature arrangement.

13. A method of operating a locking differential comprising:
energizing an electro-magnet to attract a ferrous armature arrangement from a first position to a second position against a biasing force; and
moving a locking collar in unison with the armature arrangement by pulling on a pin connecting the locking collar with the armature arrangement so that the locking collar moves from a non-locking position to a locking position.

14. The method of claim 13, further comprising deenergizing the electro-magnet to enable the biasing force to move the armature arrangement back to the first position.

15. A locking arrangement for a locking differential, the locking arrangement including:
a locking collar movable between a locking position and a non-locking position relative to a locking gear of the locking differential, the locking collar engaging the locking gear to rotationally fix the locking collar and locking gear together when in the locking position, the locking collar being rotatable relative to the locking gear when in the non-locking position;
an armature arrangement including an armature frame that is axially movable between first and second positions, the armature frame being biased to the first position, and the armature frame being formed of ferrous material; and
a pin extending between opposite first and second ends, the first end of the pin being axially fixed to the locking collar and the second end of the pin being axially fixed to the armature arrangement.

16. The locking arrangement of claim 15, wherein the armature arrangement includes a positioning collar that is axially fixed to the armature frame, the positioning collar being rotatable relative to the armature frame; and wherein the second end of the pin is axially fixed to the positioning collar.

17. The locking arrangement of claim 16, wherein the second end of the pin is press fit to the positioning collar.

18. The locking arrangement of claim 16, wherein the second end of the pin is held to the positioning collar by a snap-ring.

19. The locking arrangement of claim 15 wherein the pin is one of a plurality of pins, each of the pins extending between respective first ends and respective second ends, the first end of each pin being axially fixed to the locking collar and the second end of each pin being axially fixed to the armature arrangement.

20. The locking arrangement of claim 15, further comprising a stator holding an electro-magnet, the electro-magnet configured to move the armature arrangement to the second position when the electro-magnet is energized, wherein the armature frame is biased to the first position by a biasing member disposed at an opposite side of the armature frame from the pin.
